(19) United States
(12) Patent Application Publication
(10) Pub. No.: US 2025/0346062 A1
(43) Pub. Date: Nov. 13, 2025

(54) ADJUSTABLE PAINT ROLLER SQUEEGEE TOOL AND METHOD OF USE

(71) Applicant: Steven Davenport, Nashua, NH (US)

(72) Inventor: Steven Davenport, Nashua, NH (US)

(21) Appl. No.: 19/205,964

(22) Filed: May 12, 2025

Related U.S. Application Data
(60) Provisional application No. 63/646,586, filed on May 13, 2024.

(51) Int. Cl. B44D 3/00

(52) U.S. Cl. CPC B44D 3/006

(57) ABSTRACT

An adjustable paint roller cover squeegee tool is disclosed. The squeegee tool has two congruent members bolted using a common screw wherein the common screw is used for movement of the members similar to movement of a scissors. Each member has an elongated handle portion and a curved jaw portion, the jaw portions are configured to make a circular hole for a snug fit around a roller cover. In embodiments with an optional diameter limiting system, an adjustment screw can be laterally passed through one of the members along a continuous opening and can abut against a peg to limit the minimum diameter of the opening of the squeegee tool. In embodiments without an optional diameter limiting system, a use can simply squeeze the tool together around the roller cover using light pressure. The squeegee tool can be manually forced down the length of the roller cover to remove paint.

### RELATED APPLICATIONS

This application claims the benefit of U.S. Provisional Application Ser. No. 63/646,586, filed May 13, 2024, entitled AN ADJUSTABLE PAINT ROLLER SQUEEGEE TOOL AND METHOD OF USE, the entire disclosure of which is herein incorporated by reference.

### FIELD OF THE INVENTION

The present invention generally relates to the field of paint roller cover cleaning tools and, more specifically, the present invention relates to a novel paint roller cover squeegee tool having adjustable scraping blades for snugly fitting around and cleaning up paint roller covers of different diameters.

### BACKGROUND OF THE INVENTION

Painting with roller covers is a popular and efficient method of applying paint to walls, ceilings, and other surfaces. Paint roller covers are used commonly by both professional painters and amateurs, such as DIY painters, for painting different surfaces. Paint roller covers offer several advantages over other methods, such as using brushes or sprayers. Paint roller covers allow painters to cover large areas quickly and to help them produce a more even and uniform finish than brushes or sprayers. However, cleaning the roller covers to remove paint from them can be a time-consuming and messy process, requiring significant amounts of water or other solvents to remove all traces of paint.

Many paint commercially available paint roller covers have an advertised 2 inch diameter, however, different conventional roller covers available commercially have varying different diameters, which can make it difficult to find a tool that fits each cover snugly enough to remove all of the paint in one pass. Existing paint roller squeegees are often designed for a fixed diameter, which means they may not work effectively on roller covers of varying diameters. This can result in incomplete paint removal, or damage to the roller cover due to excessive pressure or slipping. The use of excess water or solvent during cleaning also poses an environmental problem, as well as being wasteful and costly. People end up buying multiple paint roller squeegees which is not only costly but storage for multiple squeezes is also cumbersome.

Existing paint roller cover squeegees are difficult to use and require use of both hands of a user while using the squeegee to clean paint out of a paint roller cover. This reduces the efficiency of the cleaning operation and often requires additional help. Existing squeegees often do not allow a user to apply force effectively in a squeezing direction, and do not allow a user to easily apply force in the cleaning direction along the length of the roller. This makes cleaning difficult because the user cannot easily squeeze the tool effectively around the roll while also applying force in a different direction to slide the tool down the length of the cover. Furthermore, existing roller squeegees are limited to certain diameters of paint roller covers. Few squeegees are available for different diameters and those that exist are restricted to only a limited range of diameters. Further, their cleaning efficiency is reduced when their size is varied for cleaning different roller covers.

Therefore, there is a need for a paint roller squeegee tool that can effectively clean roller covers of varying diameters, using less water or solvent, and reducing the time and effort required for cleaning. There is also a long felt need for an improved paint roller squeegee tool that can be easily used with only the user's dominant hand. Further, there is a long felt need in the art for an improved paint roller cover cleaner that effectively cleans roller covers in one pass. Additionally, there is a need for a cover cleaner that allows a user to easily apply force in a sliding direction parallel to the roller axis. Furthermore, there is a long felt need in the art for a paint roller cover that can be used by both professionals and amateur painters for cleaning up their roller covers. Finally, there is a long felt need in the art for a paint roller cover that provides a more effective, efficient, and environmentally friendly solution to the problem of cleaning roller covers of varying diameters.

### SUMMARY OF THE INVENTION

This invention overcomes disadvantages of the prior art by providing a squeegee tool and method for snugly fitting around a paint roller cover in a way that paint is cleaned out of the roller cover easily and effectively in a single pass without using much water or other solvent. The tool is configured to be adapted to fit around roller covers of different sizes and different naps without risk of damage to the tool and the roller cover. The tool allows a user to scrape paint from a roller cover by using light pressure to squeeze the tool around a roller cover and forcing the tool along the length of the roller cover in a cleaning direction. Only light pressure is required to remove nearly all paint from the roller cover.

In various embodiments, the tool can also have an optional diameter limiting system that allows the user to set a preselected minimum diameter that the tool can be closed to. This optional diameter limiting system allows a user to use up to the full strength of one hand to squeeze tightly while maintaining a preselected diameter that does not bind on the roller cover, regardless of excess squeezing pressure applied by the user.

The tool can also allow a user to apply additional pressure at push spots that can be used to push the squeegee in a cleaning direction parallel to the central axis of the cylindrical roller cover, while not getting paint on the pushing finger. Furthermore, it can be used by both professional painters and amateur painters for cleaning out roller covers of different diameters.

In various embodiments, the cleaning apparatus includes a first member and a second member connected at a pivot point near to an operative front end of each member to form a tong with a scissors-like action. The operative front end of each member is curved such that, in a closed configuration, the curved portions of the two members form jaws that can create a substantially circular opening. An operative rear end of both the members extends crossing each other at the pivot point to form handles for gripping the adjustable paint roller squeegee tool. The length of the operative front end can be shorter than the length of the operative rear end, wherein the members can be flat to provide a planar surface of predetermined width and thickness. The jaw members form a hole that fits around a cover and can be manually forced down along the longitudinal length of the roller cover.

In various embodiments, the apparatus can include an optional diameter limiting system that can be at the handle portions of the members. For changing diameter of the hole created by the jaw portions, a peg, such as a screw or other rigid object, can be vertically accommodated in one of a plurality of collinear holes disposed in one of the members wherein a portion of the screw is extended vertically out of the member to limit the extent that the handles can be closed together, thereby limiting how small the diameter of the jaws can be closed. The closer the handles are closed together, the smaller the diameter of the jaws. In various embodiments, an adjustment screw can extend through the second member along its width and slightly beyond, such that the adjustment screw moves perpendicular to the peg, wherein an extended portion of the adjustment screw meets the peg to prevent the handles of the apparatus from further inward movement beyond a position determined by a user based on a diameter of the roller sleeves to be cleaned. The adjustment screw can be positioned horizontally across the other member wherein the shaft portion of the adjustment screw abuts against the extended-out body portion of the peg positioned in the first member to limit the minimum jaw diameter to a size determined by the user.

In various embodiments, the curved portions of the members of the roller cleaner have a flattened smooth inner surface to align the inner surfaces of the curved portions around a curvature of the roller sleeve to be cleaned. The curved portions of the cleaning jaws can have a curve that changes along the length of the member thereby allowing a single cleaning tool to be adapted for various diameter rollers. In various embodiments, the curve can have a radius that decreases along the length of the jaw from the pivot point to the distal tip of the jaw, so that the radius of the curve is tightest at the end of the jaw farthest from the handle.

In various embodiments, the tool can be made from aluminum, fiberglass reinforced resin, and/or lightweight metal. The tool can include a logo or any other indicia embossed or carved on the handle portions.

In various embodiments, the paint roller cover squeegee is adjustable to fit various roller cover sizes and the handle portions having ergonomic construction that allows for easy squeezing to bring the jaw portions towards each other to make an approximately circular hole to fit around a roller cover. The squeegee can also have a place where a finger or tool can be placed for the user to push the squeegee in a cleaning direction along the central axis of the roller.

In various embodiments, a method of cleaning a paint roller cover using an adjustable paint roller cover squeegee is described. The method comprising the steps of providing an adjustable paint roller cover squeegee comprising a first member and a separate second member, the first member having an elongated handle portion and a scraping jaw portion having a curved shape, the second member having a similar elongated handle portion and a jaw portion, the first member and the second member being pivotally and detachably attached together using a mechanical fastener fastened across the holes disposed in the members, and the jaw portions being configured to fit around a roller cover; squeezing the handle portions of the first member and the second member towards each other to bring the jaw portions towards each other and form a hole therebetween adapted to fit around a roller cover; holding the roller cover with one hand and placing the circular hole of the squeegee around the roller cover; and sliding the squeegee along the longitudinal length of the roller cover from one end to the other end, thereby scraping off paint from the roller cover and into a paint tray or container. In various embodiments, the method of cleaning a paint roller cover can also include using an optional diameter limiting system to set the cleaning tool to a preselected minimum diameter that corresponds to the diameter of the roller cover.

In various embodiments, a tool for removing a fluid from a paint roller cover can include a first member having a first handle portion and a first curved jaw portion, the first curved jaw portion having a first curved scraping area sized and shaped to engage with a paint roller cover, a second member having a first handle portion and a second curved jaw portion, the second curved jaw portion having a second curved scraping area sized and shaped to engage with the paint roller cover, and a fastener that passes through a first hole in the first member and a second hole in the second member to pivotably secure the first member and the second member together, wherein when the first member and second member are pivoted relative to each other, the first jaw portion and the second jaw portion can come together to form a scraper opening that can accommodate a paint roller.

In various embodiments, the first member and the second member can be flat. The first member and the second member can define an S-shaped curve that allows for a size of the scraper opening to vary while remaining approximately circular. The first member and the second member can have a bulb at the end of the jaws where the jaws overlap when they are in a closed configuration. The first member and the second member can be identical. The tool can include a diameter limiting system that can prevent the tool from closing beyond a predetermined level. The diameter limiting system can include an adjustment screw and a peg, wherein the adjustment screw and the peg can have axes that are in planes that are 90 degrees from each other.

In various embodiments, a method of cleaning a paint roller can include opening a paint roller cover squeegee tool into an open configuration, wherein the tool has a first member and a second member that pivot relative to each other, the first member and the second member each having a handle portion and a curved jaw portion, the curved jaw portion having a curved scraping area sized and shaped to engage with a paint roller cover, wherein when the first member and second member are pivoted relative to each other into an open configuration, the ends of the first jaw portion and the second jaw portion can be separated. The method can include placing the jaw portions around a paint roller cover, bringing the handle portions together to close the jaw portions around the paint roller cover in a closed configuration, pushing the tool in a direction parallel to the central axis of the paint roller cover, and removing the paint from the paint roller.

The method can further include adjusting an optional diameter limiting system to limit the diameter of a scraper opening to at least approximately match the diameter of the paint roller cover.

### BRIEF DESCRIPTION OF THE DRAWINGS

The invention description below refers to the accompanying drawings, of which:

FIG. 1A is a perspective view of an adjustable paint roller cover squeegee, according to an illustrative embodiment;

FIG. 1B is a perspective view of an adjustable paint roller cover squeegee with an optional diameter limiting system, according to an illustrative embodiment;

FIG. 2 is a bottom perspective view of an adjustable paint roller squeegee, according to an illustrative embodiment;

FIG. 3 is a perspective view showing engagement of the peg and the screw of the optional diameter limiting system, according to an illustrative embodiment;

FIG. 4A is a perspective view showing the adjustable paint roller squeegee being used for cleaning up a roller cover, according to an illustrative embodiment;

FIG. 4B is a perspective view showing the adjustable paint roller squeegee being pressed along the length of the roller cover towards the free end of the roller cover, according to an illustrative embodiment;

FIG. 5A is a perspective view showing an adjustable paint roller squeegee with an optional diameter limiting system being used for cleaning up a roller cover, according to an illustrative embodiment;

FIG. 5B is a perspective view showing the adjustable paint roller squeegee with an optional diameter limiting system being pressed along the length of the roller cover towards the free end of the roller cover to clean the paint from the roller cover, according to an illustrative embodiment;

FIG. 6 is a side perspective view of an adjustable paint roller squeegee adapted for different paint roller covers, according to an illustrative embodiment;

FIG. 7 is an exploded view of an adjustable paint roller squeegee, according to an illustrative embodiment;

FIG. 8 is a top view of a full assembled adjustable paint roller squeegee in an open configuration, according to an illustrative embodiment;

FIG. 9A is a perspective view of a fully assembled adjustable paint roller squeegee in a closed configuration, according to an illustrative embodiment;

FIG. 9B is a top view of the fully assembled adjustable paint roller squeegee of FIG. 9A in a closed configuration, according to an illustrative embodiment;

FIG. 9C is a side view of the fully assembled adjustable paint roller squeegee of FIG. 9A in a closed configuration, according to an illustrative embodiment;

FIG. 10 is a perspective view of a fully assembled adjustable paint roller squeegee in a collapsed, storable configuration, according to an illustrative embodiment;

FIG. 11 is a top view of a full assembled adjustable paint roller squeegee with scissor grips in an open configuration, according to an illustrative embodiment;

FIG. 12A is a perspective view of a fully assembled adjustable paint roller squeegee with scissor grips in a closed configuration, according to an illustrative embodiment;

FIG. 12B is a top view of the fully assembled adjustable paint roller squeegee with scissor grips of FIG. 12A in a closed configuration, according to an illustrative embodiment;

FIG. 12C is a side view of the fully assembled adjustable paint roller squeegee with scissor grips of FIG. 12A in a closed configuration, according to an illustrative embodiment;

FIG. 13 is a perspective view of a fully assembled adjustable paint roller squeegee with scissor grips in a collapsed, storable configuration, according to an illustrative embodiment;

FIG. 14A is an exploded view of an adjustable paint roller squeegee with scissor grips, according to an illustrative embodiment, according to an illustrative embodiment;

FIG. 14B is a top view of a disassembled fully adjustable paint roller squeegee with scissor grips, showing the two members stacked together, according to an illustrative embodiment;

FIG. 15 is a perspective view showing the adjustable paint roller squeegee with scissor grips being used for cleaning up a partially cut-away roller cover, according to an illustrative embodiment; and

FIG. 16 is a chart showing a method of use for a multipurpose adjustable paint roller squeegee, according to an illustrative embodiment.

### DETAILED DESCRIPTION

There are a great many possible implementations of the invention, too many to describe herein. Some possible implementations are described below. In the following description, for purposes of explanation, numerous specific details are set forth in order to provide a thorough understanding thereof. It should be clear, however, that the innovation can be practiced without various specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, any particular embodiment need not have all the aspects or advantages described herein. Thus, in various embodiments, any of the features described herein from different embodiments may be combined. It cannot be emphasized too strongly, however, that these are descriptions of implementations of the invention, and not descriptions of the invention, which is not limited to the detailed implementations described in this section but is described in broader terms in the claims.

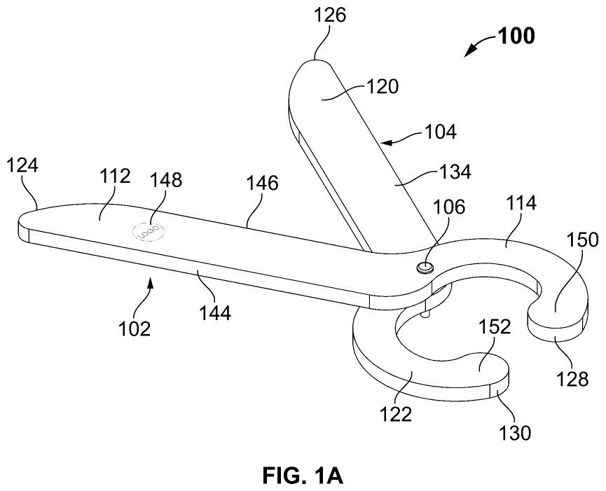

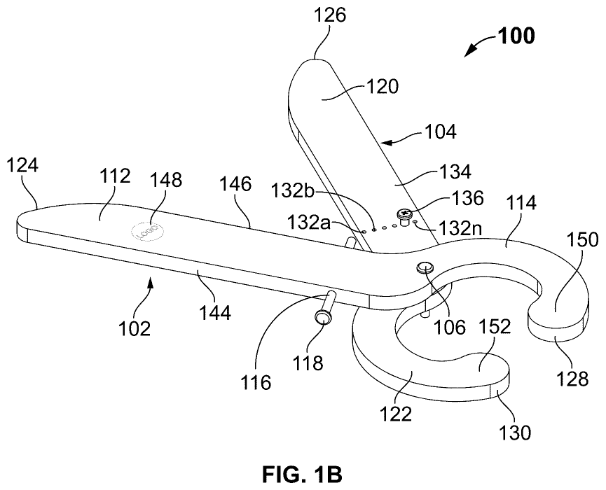

FIG. 1A is a perspective view of an adjustable paint roller cover squeegee, according to an illustrative embodiment. As used herein, the term “paint roller cover squeegee” refers to a tool or device that can be used to squeeze and wipe paint away from a paint roller. This adjustable paint roller cover squeegee pushes the liquid paint off of the surface of the roller, with the liquid paint being forced off of the roller and collecting in front of the squeegee as the squeegee is moved along the length of the roller.

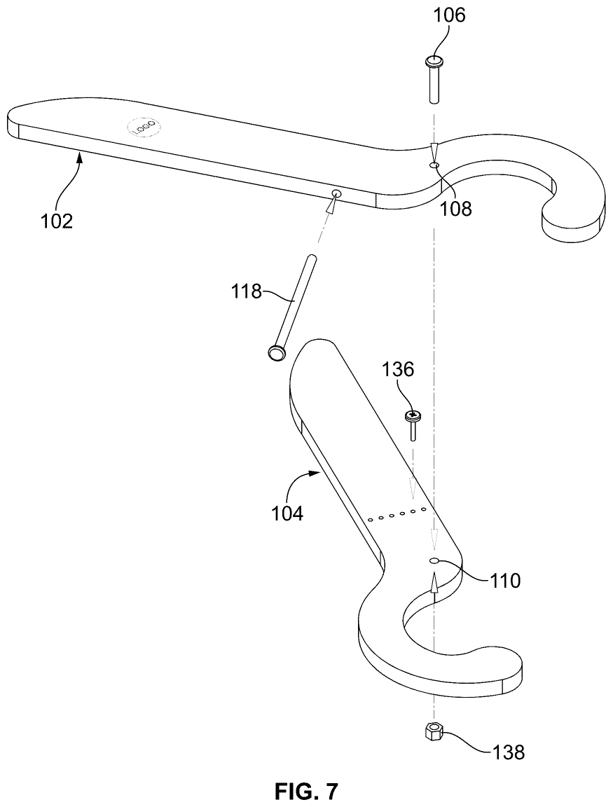

Various embodiments of the adjustable paint roller cover squeegee 100 can be designed to be used by both professionals and amateur painters and for single use or multiple uses. The adjustable paint roller cover squeegee 100 includes a first member 102 and a separate second member 104. The first member 102 and the second member 104 can be complimentary, and can be congruent and identical in design, shape, and structure. The first member and the second member can be pivotally and detachably attached together using a mechanical fastener 106 fastened through holes 108, 110 in the members 102, 104 respectively as illustrated in FIG. 7. More specifically, the members 102, 104 are pivoted relative to each other similar to the pivoted members of a conventional scissors. It should be noted that the first member and second member can be assembled with one member on top for right-handed use, and with the other member on top for left-handed use. By assembling the first member and second member in a different arrangement, the tool can be adapted for right-handed use or left-handed use.

The first member 102 can have a one-piece construction and can have an elongated handle portion 112 and a scraping jaw portion 114 having a curved (concave) shape. The hole 108 can be positioned between the handle portion 112 and the jaw portion 114. Both the members 102, 104 are solid and can be made of any durable material including but not limited to metal, aluminum, resin reinforced fiberglass, heavy-duty plastic and more. Embodiments of the present invention are intended to include or otherwise cover any type of the material for the tool 100 including known, related art, and/or later developed technologies. Both members can be relatively flat. Although the word planar can be used herein to describe each member, both members can have sufficient thickness to provide strength to the tool and avoid unwanted flexibility in the rigid tool. Although having a thickness, both members can be referred to as planar and can have a minimal thickness that allows the tool to be stored flat in a compact manner. In various embodiments, the assembled tool can have a total thickness that can be approximately 3 mm or less. In various embodiments, each member can have thicknesses that can be approximately 5 mm or less. In various embodiments, the assembled tool can have a total thickness that can be approximately 7 mm or less. In various embodiments, the assembled tool can have a total thickness that can be approximately ⅛ of an inch.

The second member 104 also has similar elongated handle portion 120 and a jaw portion 122. In various embodiments, the first member 102 and the second member 104 can be identical, so that first member 102 and second member 104 can be manufactured using the same manufacturing process and equipment. The hole 110 is aligned with the hole 108 and is positioned directly below the hole 108 allowing the fastener 106 to pivotally bolt the members 102, 104 together. The handle portions 112, 120 can have ergonomic construction, and the free ends 124, 126 of the respective handle portions 112, 120 are pulled towards each other to squeeze the handle portions to bring the jaw portions 114, 122 towards each other to make a circular, or approximately circular, scraper opening therebetween to fit around a typical roller cover. Put another way, the jaw portions can be brought together to define a scraper opening between them. The scraper is formed by the rigid jaws when they are brought into contact with each other, and the opening between the jaws when they are brought into contact with each other can be referred to as a scraper opening.

As used herein, the word scraper refers to the portions of the paint roller cover squeegee tool 100 that can be placed in contact with the paint roller cover and can scrape paint away from the roller cover when the jaws are closed around the roller cover. The inner curved portions of the jaws form the scraper when the jaws are brought together. The sides of the scraper opening can be defined by scraper areas on the concave jaws. The concave jaws can be opened into an open configuration to pass the jaws around the paint roller, and can be closed around the paint roller to form the scraper around the paint roller when the tool is in a closed configuration. In various embodiments, the scraper areas can approximate half-cylinders, and the two approximately half-cylinder areas can form the scraper.

The orientation of the members 102, 104 with the first member 102 positioned above the second member 104 allows the free ends 128, 130 of the jaw portions 114, 122 to cross over each other. The extent to which the two jaws overlap can vary depending on the diameter of the roller to be cleaned. The jaw portions 114, 122 each have a concave shape that defines a scraping area, and the scraping area of each jaw is designed to engage with a paint roller cover to scrape away paint. The concave structures of the jaw portions 114, 122 are dimensioned to fit over an outer contour of various sizes of paint rollers so as to facilitate scraping of an outer surface of the paint roller as the paint roller passes through the scraper opening. The two concave scraping areas of the two jaws can be closed together around paint roller covers of varying sizes to encircle the paint roller cover so that all paint, or nearly all paint, can be scraped off of the paint roller cover.

In various embodiments, the curved portions of the cleaning jaws can have a curve that changes along the length of the jaw thereby allowing a single cleaning tool to be adapted for various diameter rollers. In various embodiments, the curve can have a radius that decreases along the length of the jaw from the pivot point to the distal tip of the jaw, so that the radius of the curve is tightest at the end of the jaw farthest from the handle. In various embodiments, the jaw portions 114, 122 can individually have an inside radius of 1⅚ inches and, when pushed towards each other by a user by pulling the handle portions 112, 120, form a resulting hole having a radius of about 1¾ inches. In various embodiments, the resulting hole can have a radius of approximately 1¾ inches diameter, however, larger or smaller holes are possible depending on how close together the user pushes the handle portions towards each other.

In various embodiments, the jaws can have a wider portion, or bulb, 150, 152 at the end of the jaws. This wider bulb allows the two ends of the jaws to overlap in a way that allows for a nearly circular opening that can be adjusted for different diameter roller covers and/or different levels or heights of nap on the roller, while still maintaining an approximately circular shaped opening that can encircle various roller covers. The decreased radius of the curve near the bulb can also help to create a nearly circular opening across a range of possible diameters. Similarly, a member can also have an S-curve near the pivot point that allows for the two members to approximate a circular curve near the pivot, regardless of the desired diameter of the opening. An apex of the inner curve of the opening can be defined as the apex spot near the pivot where both members come together and are both forming the side of the opening together. As the jaws are moved open and closed, that apex spot can be shifted along the S-curve of both members, and the shape of that curve allows for the apex spot to approximate the curve of a circle, regardless of the diameter. The proximal portion of the jaw can have an inner contact surface with curve that has a radius that increases farther from the distal end. In an embodiment, the edge of the jaw can have a radius that can increase to infinity before curving back in the other direction, thereby forming the S-curve. The combination of the tight radius at the distal end of the jaw, the bulb at the distal end of the jaw, and the expanding radius of the curve near the pivot point can contribute to a shape that accommodates a wide range of roller diameters while still approximating a circular opening.

A user can apply light pressure to close the jaws around the roller cover, and can easily slide the device along the length of the roller cover to remove nearly all paint from the roller cover. While maintaining light pressure to keep the jaws closed around the roller cover, the user can simultaneously apply force in a direction parallel to the central axis of the cylindrical roller cover to slide the squeegee along the roller cover, thereby removing the paint from the cover.

The handle portions 112, 120 can have a logo 148 printed thereon for branding and marketing purposes. The logo 148 can be in the form of insignia, badge, emblem, decoration, alphanumeric symbol, or artistic rendition that can adhere permanently on the handle portion 112, 120.

FIG. 1B is a perspective view of an adjustable paint roller cover squeegee with an optional diameter limiting system, according to an illustrative embodiment. An optional diameter limiting system can limit how far the jaws can be closed, thereby limiting the minimum diameter of the scraper opening formed by the jaws. The optional diameter limiting system can include an adjustment screw and a peg. In various embodiments, one or both of the adjustment screw and/or peg can be moved or adjusted to change the minimum diameter of the scraper opening formed by the jaws. In various embodiments, the adjustment screw and the peg can have axis that are in planes that can remain at 90 degrees to each other as the tool is moved between an open configuration and a closed configuration.

A continuous opening 116 can be disposed through the handle, extending from side edge 144 to side edge 146 of the first member 102, wherein the opening 116 is configured to allow an adjustment screw 118 to pass horizontally therethrough. Any conventional screw fastener can be positioned through a threaded opening 116, and the adjustment screw 118 does not slide through, and is supported by, the solid body of the first member 102. The length of the adjustment screw 118 is longer than the width of the first member 102 such that a portion of shaft and the head can extend out in opposite directions of the first member 102. In various embodiments, the adjustment screw can be adjusted inward to increase the minimum diameter of the scraper opening formed by the jaws.

The handle portion 120 of the second member 104 can have a plurality of collinear holes 132a-n disposed in the top surface 134 thereof. The collinear holes 132a-n can be used for accommodating a peg 136 with the at least a portion of the peg 136 extending outside the hole. Any one hole of the plurality of the holes 132a-n can be used for accommodating the peg 136. The adjustment screw 118 and peg 136 can be used for limiting the diameter of the scraper opening formed by the jaw portions 114, 122 to a predetermined diameter, with the scraping jaw portions 114, 122 forming an opening adapted to fit around a roller cover of a given size. In various embodiments, the peg can be placed in different holes to change the minimum diameter of the jaws to accommodate roller covers of different sizes and/or nap levels. In various embodiments, the peg can be a screw that can be screwed into one of the holes 132a-n.

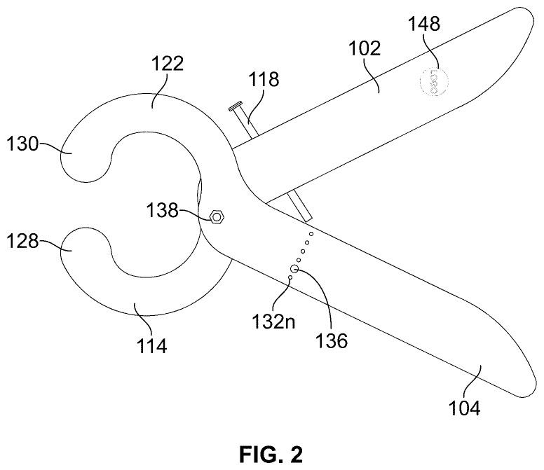

FIG. 2 is a bottom perspective view of the adjustable paint roller squeegee, according to an illustrative embodiment. The mechanical fastener 106 can be secured by a nut 138 allowing the fastener to couple the members effectively and pivotally 102, 104. Nut 138 can be a locking nut, and the locking nut can allow variable tightness between the members 102 and 104 as they pivot relative to each other around the mechanical fastener 106. A user can tighten the locking nut 138 until a desired tightness is achieved between the members 102 and 104 at the pivot. In embodiments with the optional diameter limiting system, the collinear holes 132a-n can be disposed through the second member 104 such that the peg 136 is stable and does not move when accommodated in any of the holes 132a-n.

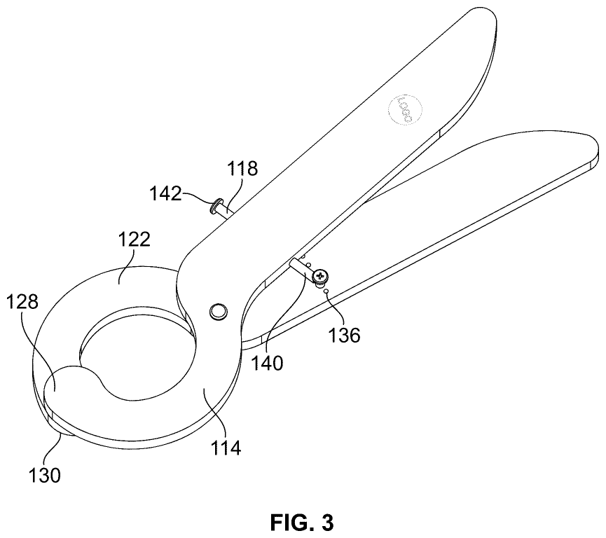

FIG. 3 is a perspective view showing engagement of the peg 136 and the adjustment screw 118 of the optional diameter limiting system, according to an illustrative embodiment. Turning now to FIG. 1B and FIG. 3, the optional diameter limiting system of the squeegee 100 can set the minimum diameter of the scraper opening formed by the jaws. This optional diameter limiting feature can set a minimum diameter, which allows the user to squeeze the jaws closed with as much force as the user wants to apply, while still preventing the jaws from squeezing too tightly around the roller cover. Without the diameter limiting system, using excessive force to squeeze the roller cover can cause the squeegee tool to bind on the roller cover, making movement in the cleaning direction more difficult, so the optional diameter limiting system allows the user to squeeze with more force than is required while preventing binding of the tool on the roller cover. In various embodiments, the user can simply position the handle portions 112, 120 to set a desired diameter and the user can hold the handle portions in the correct position. In various embodiments, a peg and/or adjustment screw can be used to set a minimum diameter. If a minimum diameter is correctly set to correspond to the diameter of the roller cover, the user can squeeze the handles together with an excess of strength without squeezing the jaws into the sides of the roller cover because the peg and/or adjustment screw will keep the jaws from closing too tightly around the roller cover.

The adjustment screw 118 positioned horizontally through the continuous opening 116 can have the shaft portion 140 positioned towards the peg 136 and the head portion 142 on the opposite side of the handle 102. When the handle portions 112, 120 are pulled towards each other (squeezed) and the members 102, 104 move pivotally, the shaft portion 140 can abut against the peg 136 that is positioned in one of the collinear holes 132a-n and thereby stop additional pivotal movement of the members 102, 104 and, as a result, achieve a desired size scraper opening formed by the jaw portions 114, 122 to accommodate a particular paint roller cover. For changing diameter of the resulting scraper opening formed by the jaw portions 114, 122, the peg 136 can be positioned in any of the other collinear holes, and/or the adjustment screw can be screwed in or out, thereby changing the distance to be traveled by the shaft portion 140 to abut against the peg 136. Put another way, the abutment of the shaft against the peg in the optional diameter limiting system can limit how close the two handles can be squeezed towards each other, thereby limiting how small of a scraper opening is formed by the jaw portions coming together. The jaw portions 114, 122 are configured to slide against each other to accommodate different roller covers and so that the free ends 128, 130 do not collide with each other.

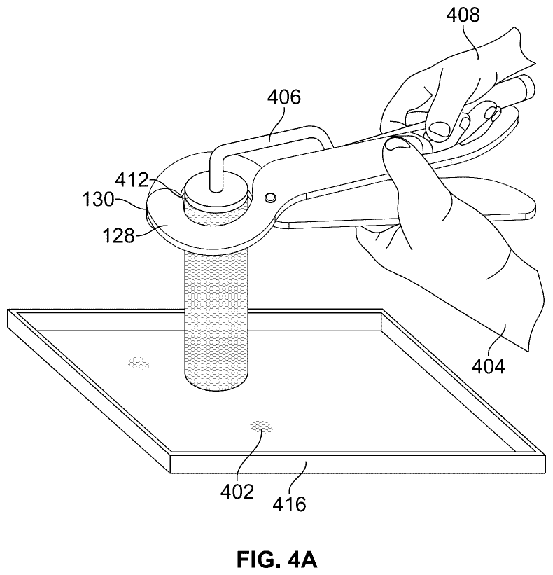

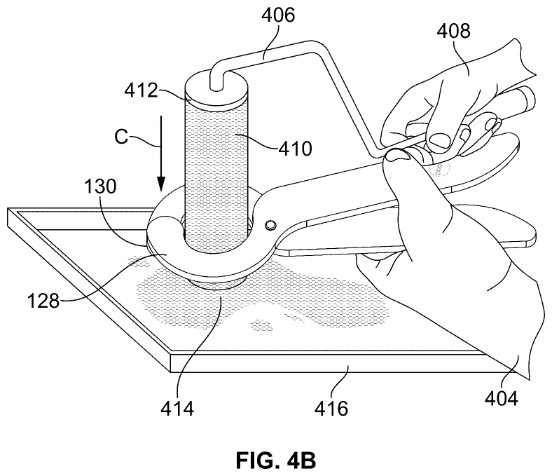

FIG. 4A is a perspective view showing the adjustable paint roller squeegee used for cleaning up a roller cover, according to an illustrative embodiment. The squeegee tool 100 is designed to be held in one hand of a user while the other hand holds the roller frame handle and cover, therefore, eliminates requirement of any additional help for cleaning up the roller cover. As illustrated, the paint roller squeegee tool 100 can be held in left hand 404, which can the dominant hand of a user (in the present embodiment), and the roller cover handle 406 is held in the right hand 408. The jaws of the paint roller squeegee tool can be closed around the paint roller to form a scraper opening, with the scraper areas of the jaws in contact with the paint roller. The user can apply light pressure to squeeze the jaws around the roller cover, thereby squeezing the scraper areas into contact with the roller cover. In use, the jaw portions 114, 122 snugly fit around the shaft end 412 of the cover 410. The free end 414 of the cover 410 is positioned in a paint tray 416 that can catch the paint 402 cleaned off from the paint roller cover 410.

FIG. 4B is a perspective view showing the adjustable paint roller squeegee being pressed along the length of the roller cover towards the free end of the roller cover to clean the paint from the roller cover, according to an illustrative embodiment. Applying light pressure to squeeze the handles together can close the jaws around the roller cover and form the scraper opening around the roller cover, and the user can apply additional force at the same time in the cleaning direction along the direction of arrow C. Only light pressure is required to squeeze the jaws together, and then the squeegee can be easily slid along the roller cover in the direction of arrow C so that the scraper areas of the scraper opening can remove all, or nearly all, of the paint from the roller cover.

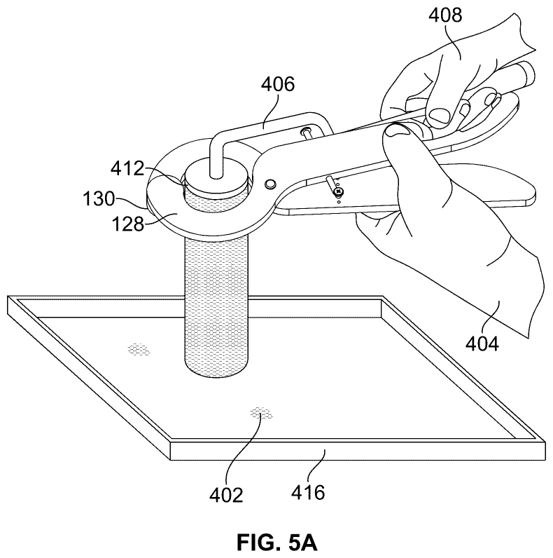

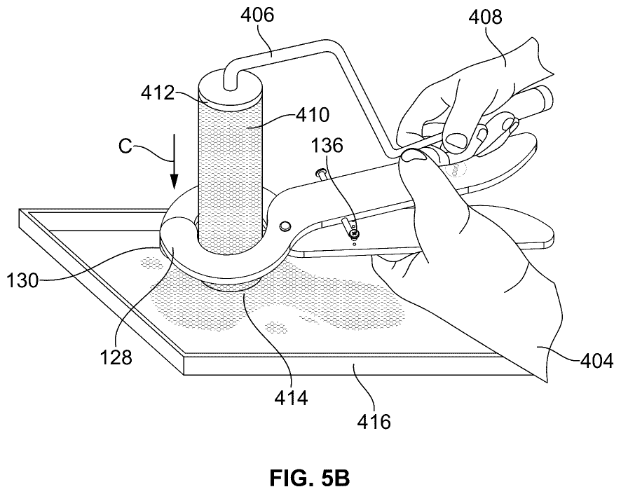

FIG. 5A is a perspective view showing an adjustable paint roller squeegee with an optional diameter limiting system being used for cleaning up a roller cover, according to an illustrative embodiment, and FIG. 5B is a perspective view showing the squeegee with an optional diameter limiting system being pressed along the length of the roller cover towards the free end of the roller cover to clean the paint from the roller cover, according to an illustrative embodiment. In embodiments with the optional diameter limiting system, the peg 136 can be positioned in an appropriate collinear hole such that the adjustment screw 118 can abut against the peg 136 and a desired size of scraper opening created by the jaw portions 114, 122 can be predetermined to fit around the roller cover 410. Turning to FIGS. 3, 5A, and 5B, the peg 136 can be positioned in any of the collinear holes 132a-n allowing the tool 100 to fit around roller covers of different diameters. The curvature of the jaw portions 114, 122 approximately conforms to the cylindrical shape of the conventional roller covers such that the jaw portions 114, 122 effectively scrape the excess paint off the roller cover 410. The tool 100 is manually forced down along the length of the roller cover 410 with the jaw portions 114, 122 scraping the roller to clean off the paint which is collected in the paint tray 416. The tool 100 can be forced along the roller cover 410 in the cleaning direction shown along arrow C. At the end of the first pass of scraping from the shaft end 412 to the free end 414 as illustrated in FIG. 5B, all, or nearly all, of the paint is cleaned off. A second pass of moving the jaw portions 114, 122 along the roller cover may not be necessary and may not remove any additional paint from the roller cover. The tool 100 effectively cleans up to 99% of the paint out of the paint roller 410 in the first pass.

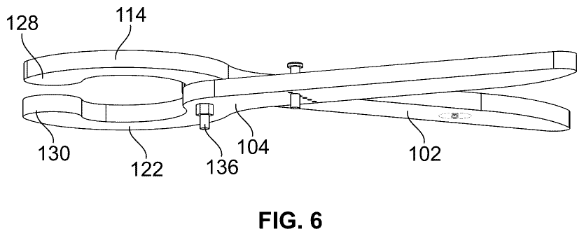

FIG. 6 is a side perspective view of an adjustable paint roller squeegee with an optional diameter limiting system adapted for different paint roller covers, according to an illustrative embodiment. The first member 102 having the horizontally positioned adjustment screw positioned above the second member 104 such that the members 102, 104 can easily squeeze together without free ends 128, 130 of the jaw portions 114, 122 colliding with each other and therefore, allowing the jaw portions 114, 122 to snugly fit around any size of paint roller covers including thin paint roller covers as well as thick paint roller covers. The free ends 128, 130 can cross each other to reduce the diameter of the hole created by the jaw portions 114, 122. Similarly, embodiments of the squeegee tool without the optional diameter limiting system can have the first member 102 positioned above the second member 104 in the same way such that the members 102, 104 can easily squeeze together without free ends 128, 130 of the jaw portions 114, 122 colliding with each other, thereby allowing the jaw portions 114, 122 to snugly fit around any size of paint roller covers.

FIG. 7 is an exploded view of the adjustable paint roller squeegee, according to an illustrative embodiment. The members 102, 104 can be congruent and identical, and can have symmetric holes 108, 110 for accommodating the fastener 106. The fastener 106 can be secured by the nut 138 positioned on the bottom side of the member 104. The members 102, 104 can be of any size for allowing users to easily handle and operate the tool 100 while cleaning any type of paint rollers. In embodiments with the optional diameter limiting system, a continuous opening 116 can be disposed laterally across the handle portion 112 and the adjustment screw 118 can be removably inserted through the opening 116.

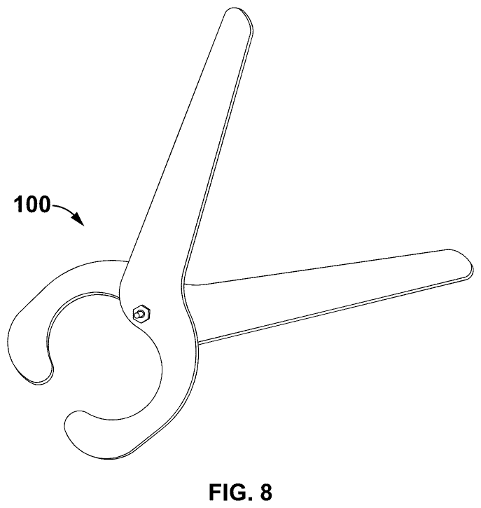

FIG. 8 is a top view of a full assembled adjustable paint roller squeegee in an open configuration, according to an illustrative embodiment. A user can open the paint roller squeegee 100 in to an open configuration, such as shown in FIG. 8, and can then easily place the tool around one end of the paint roller.

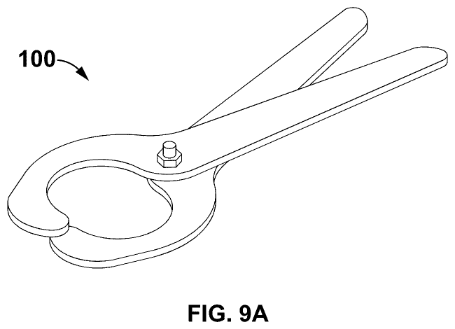

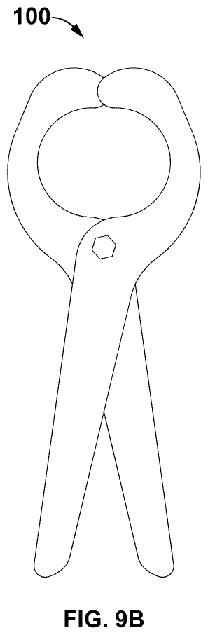

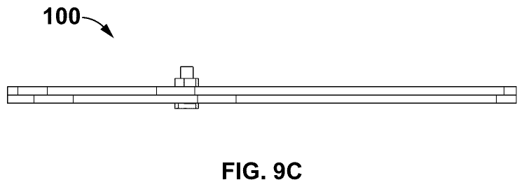

FIG. 9A is a perspective view of a fully assembled adjustable paint roller squeegee in a closed configuration, FIG. 9B is a top view of the fully assembled adjustable paint roller squeegee in a closed configuration of FIG. 9A, and FIG. 9C is a side view of the fully assembled adjustable paint roller squeegee in a closed configuration of FIG. 9A, according to an illustrative embodiment. A user can close the adjustable paint roller squeegee 100 around one end of the paint roller, placing the adjustable paint roller squeegee into a closed configuration such as shown in FIGS. 9A, 9B, and 9C. When the adjustable paint roller squeegee is in a closed configuration, the jaws can form a scraper opening. When the adjustable paint roller squeegee tool is in a closed configuration around a paint roller cover, the jaws can form a scraper opening around the paint roller cover. When the adjustable paint roller squeegee is in the closed configuration around the paint roller, thereby forming a scraper opening around the paint roller cover, the adjustable paint roller squeegee can be used to remove excess paint from the paint roller by sliding the adjustable paint roller squeegee along the length of the paint roller.

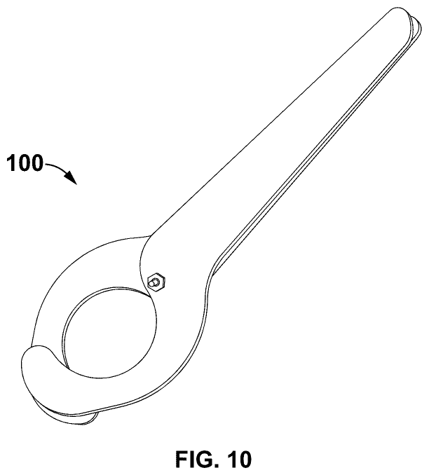

FIG. 10 is a perspective view of a fully assembled adjustable paint roller squeegee in a collapsed, storable configuration, according to an illustrative embodiment. When the adjustable paint roller squeegee 100 is not in use, a user can collapse the adjustable paint roller squeegee into a collapsed, storable configuration that can include the handles being stacked together, and can be compact, flat, and take up very little space in a tool storage area.

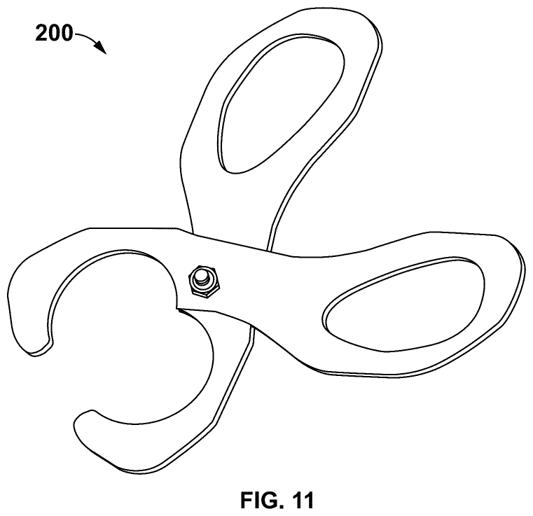

FIG. 11 is a top view of a full assembled adjustable paint roller squeegee with scissor grips in an open configuration, according to an illustrative embodiment. A user can open the paint roller squeegee 200 in to an open configuration, such as shown in FIG. 11, and can then easily place the tool around one end of the paint roller.

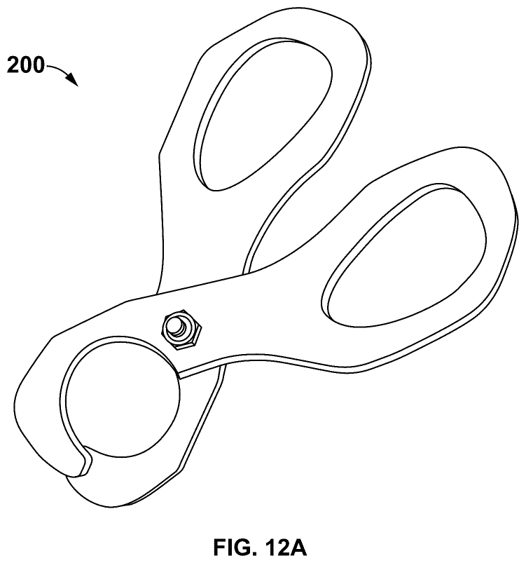

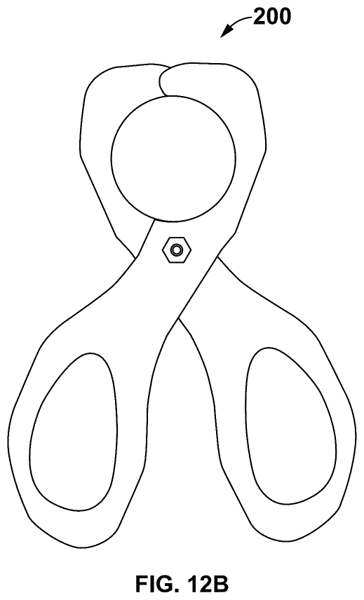

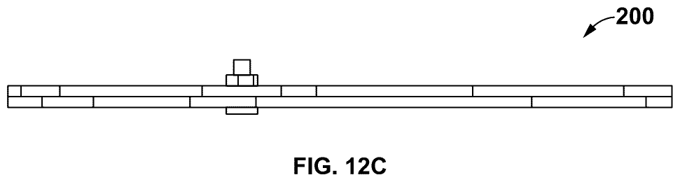

FIG. 12A is a perspective view of a fully assembled adjustable paint roller squeegee with scissor grips in a closed configuration, FIG. 12B is a top view of the fully assembled adjustable paint roller squeegee with scissor grips of FIG. 12A in a closed configuration, and FIG. 12C is a side view of the fully assembled adjustable paint roller squeegee with scissor grips of FIG. 12A in a closed configuration, according to an illustrative embodiment. A user can close the adjustable paint roller squeegee 200 around one end of the paint roller, placing the adjustable paint roller squeegee into a closed configuration such as shown in FIGS. 12A, 12B, and 12C. When the adjustable paint roller squeegee is in a closed configuration, the jaws can form a scraper opening. When the adjustable paint roller squeegee tool is in a closed configuration around a paint roller cover, the jaws can form a scraper opening around the paint roller cover. When the adjustable paint roller squeegee is in the closed configuration around the paint roller, thereby forming a scraper opening around the paint roller cover, the adjustable paint roller squeegee can be used to remove excess paint from the paint roller by sliding the adjustable paint roller squeegee along the length of the paint roller.

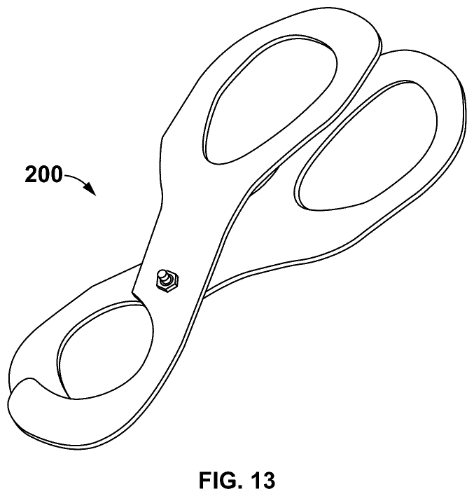

FIG. 13 is a perspective view of a fully assembled adjustable paint roller squeegee with scissor grips in a collapsed, storable configuration, according to an illustrative embodiment. When the adjustable paint roller squeegee 200 is not in use, a user can collapse the adjustable paint roller squeegee into a collapsed, storable configuration that can include the handles being stacked together, and can be compact, flat, and take up very little space in a tool storage area.

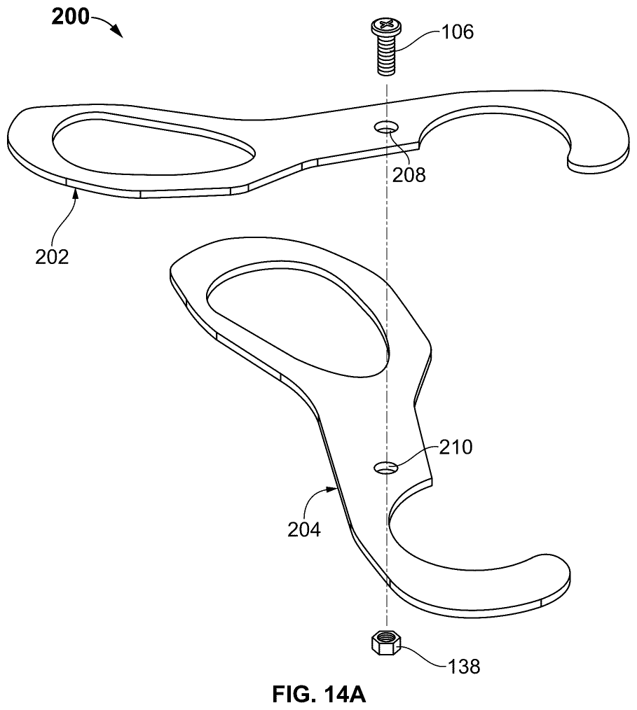

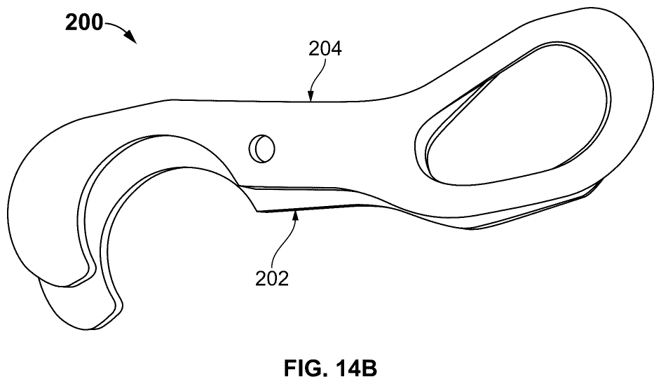

FIG. 14A is an exploded view of an adjustable paint roller squeegee with scissor grips, according to an illustrative embodiment, according to an illustrative embodiment. In various embodiments, the members 202, 204 can be congruent and identical, and can have symmetric holes 208, 210 for accommodating the fastener 106. The fastener 106 can be secured by the nut 138 positioned on the bottom side of the member 204. The members 202, 204 can be of any size for allowing users to easily handle and operate the tool 200 while cleaning any type of paint rollers. In embodiments with the optional diameter limiting system, a continuous opening can be disposed laterally across a handle portion of a member, and an adjustment screw can be removably inserted through an opening in the member.

FIG. 14B is a top view of a disassembled fully adjustable paint roller squeegee with scissor grips, showing the two members stacked together, according to an illustrative embodiment. The two members 202, 204 can be the same, and can be manufactured easily by a process that makes a single version of the member. A complete paint roller squeegee with scissor grips can be assembled from two identical members. The first member and second member can be assembled with one member on top for right-handed use, and with the other member on top for left-handed use. By assembling the first member and second member in a different arrangement, the tool can be adapted for right-handed use or left-handed use

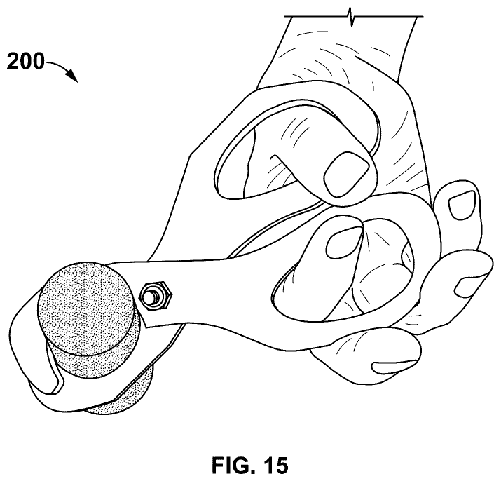

FIG. 15 is a perspective view showing the adjustable paint roller squeegee with scissor grips being used for cleaning up a partially cut-away roller cover, according to an illustrative embodiment

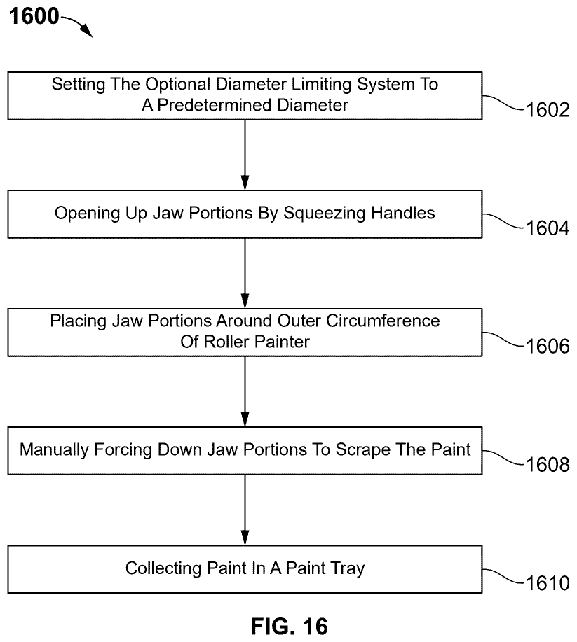

FIG. 16 is a chart showing a method of use for an adjustable paint roller cover squeegee, according to an illustrative embodiment. At box 1602, for embodiments with an optional diameter limiting system, a user can optionally place a screw in one of the collinear holes and/or adjust an adjustment screw to define a central hole of a predetermined desired size using the jaw portions of the tool. At box 1604, the user opens up jaw portions by pulling apart the free ends of the handle portions of the members of the tool. At box 1606, the user places the jaw portion around the shaft end of the roller cover and the jaw portion can be closed around the roller cover. The jaw portion can snugly fit around the roller cover to form a scraper opening. The user can apply a light pressure to close the jaws around the cover. Forceful squeezing is not necessary. At box 1608, the user manually forces the jaw portions downward along the cleaning direction to scrape the paint out of the roller cover until the squeegee reaches the free end of the roller cover. Optionally, a user can place a finger on the bulb to help push the tool down the length of the roller cover. At box 1610, the user collects the paint in a paint tray and the collected paint can be reused and/or can be collected in a container.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

The squeegee tool described herein can be adapted for use in nearly any environment by both professional painters and amateur painters. The squeegee can be used with only one hand to clean out paint in a single pass. As the tool is manually forced down the length of the roller cover, the paint is cleaned out easily and effectively in a single pass.

It should be clear that the squeegee tool described herein can be of any suitable size and configuration as is known in the art without affecting the overall concept of the invention, provided that it accomplishes the above stated objectives. One of ordinary skill in the art will appreciate that the squeegee tool shown in the figures is for illustrative purposes only, and that many other sizes and shapes of the squeegee tool are well within the scope of the present disclosure. Although the dimensions of the squeegee tool are important design parameters for user convenience, the squeegee tool may be of any size that ensures optimal performance during use and/or that suits the user's needs and/or preferences.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 5%) of the system. Accordingly, this description is meant to be taken only by way of example, and not to otherwise limit the scope of this invention.

What is claimed is:

1. A tool for removing a fluid from a paint roller cover comprising:
a first member having a first handle portion and a first curved jaw portion, the first curved jaw portion having a first curved scraping area sized and shaped to engage with a paint roller cover;
a second member having a second handle portion and a second curved jaw portion, the second curved jaw portion having a second curved scraping area sized and shaped to engage with the paint roller cover; and
a fastener that passes through a first hole in the first member and a second hole in the second member to pivotably secure the first member and the second member together, wherein when the first member and second member are pivoted relative to each other, the first jaw portion and the second jaw portion can come together to form a scraper opening that can accommodate a paint roller.

2. The tool of claim 1, wherein the first member and the second member are flat.

3. The tool of claim 1, wherein the first member and the second member define an S-shaped curve that allows for a size of the scraper opening to vary while remaining approximately circular.

4. The tool of claim 1, wherein the first member and the second member have a bulb at the end of the jaws where the jaws overlap when they are in a closed configuration.

5. The tool of claim 1, wherein the first member and the second member are identical.

6. The tool of claim 1, further comprising a diameter limiting system that prevents the tool from closing beyond a predetermined level.

7. The tool of claim 6, wherein the diameter limiting system includes an adjustment screw and a peg, wherein the adjustment screw and the peg have axis that are in planes that are 90 degrees from each other.

8. A method of cleaning a paint roller cover comprising:
opening a paint roller cover squeegee tool into an open configuration, wherein the tool has a first member and a second member that pivot relative to each other, the first member and the second member each having a handle portion and a curved jaw portion, the curved jaw portion having a curved scraping area sized and shaped to engage with a paint roller cover, wherein when the first member and second member are pivoted relative to each other into an open configuration, the ends of the first jaw portion and the second jaw portion can be separated;
placing the jaw portions around a paint roller cover;
bringing the handle portions together to close the jaw portions around the paint roller cover in a closed configuration;
pushing the tool in a direction parallel to the central axis of the paint roller cover; and
removing the paint from the paint roller cover.

9. The method of claim 8, further comprising adjusting a diameter limiting system to limit the diameter of a scraper opening to approximately match the diameter of the paint roller cover.
